(19) United States
(12) Patent Application Publication
(10) Pub. No.: US 2017/0034259 A1
(43) Pub. Date: Feb. 2, 2017

(54) Associating Code Instances Without User Input

(71) Applicant: Gimbal, Inc., San Diego, CA (US)

(72) Inventors: Kevin Hunter, La Jolla, CA (US); Charles S. Wurster, San Diego, CA (US); Jose R. Menendez, Encinitas, CA (US)

(21) Appl. No.: 14/812,683

(22) Filed: Jul. 29, 2015

(51) Int. Cl. H04L 29/08

(52) U.S. Cl. CPC H04L 67/104; H04L 67/306

(57) ABSTRACT

A server receives data from each of a plurality of code instances that characterize a location of an associated client device executing the corresponding code instance and comprising a unique instance identification (IID) that identifies such code instance. Thereafter, it can be determined, using a clustering model and based on the received data, which of the code instances are likely to be associated with each other. Next, each code instance can be grouped into one of a plurality of the groups based on the determination. Related apparatus, systems, techniques and articles are also described.

### TECHNICAL FIELD

The subject matter described herein relates to the clustering of instances of code executing on one or more client devices with a user and/or a group of users.

### BACKGROUND

Providers of services consumed over the Internet such as e-commerce services, social networking services, online review sites, advertisement networks, and marketing tools often have difficulty associating services on a client device and/or client devices for a user or a group of users. For example, a user may use several services (e.g. applications, etc.) on a client device provided by one company but login only to a subset of them. Similarly, a user may use a service across multiple client devices including smart phones (both personal and work related), tablets, video set-top boxes, cars and laptop or desktop computers (both personal and work related). Identifiers for such client devices such as cookies and operating system advertising IDs often vary across these differing platforms and/or may not be available to all the services on a single client device. These variances make it difficult to associate such services or client devices with a particular user or group of users without the user actively providing input (e.g., entering the same user name to access the service across devices).

One technique for input requires a user to enter in a username/password (text, biometric, etc.) for services provided to each client device. However, if login is not required to use the service, it is common that users may not login across all their services or devices. Furthermore, logins for many services are issued and used per user (as opposed to a group of users) which makes it difficult to determine a group of devices belonging to a group of users (e.g. a family, work colleagues, college students in the same campus).

Social networking services allow users to self-select themselves as members of a group(s). These groups can be based on various relationships including personal, familial, hobbies, teams, schools, work, etc. However, as such group memberships are self-selected, they are often incomplete (e.g., for familial groups children may not choose to join a family group with their parents, etc.) nor do they easily enable users to self-select themselves as members of a group with strangers they are physically proximate to at any given time.

### SUMMARY

In one aspect, a server receives data from each of a plurality of code instances that characterize a location of an associated client device executing the corresponding code instance and comprising a unique instance identification (IID) that identifies such code instance. Thereafter, it can be determined, using a clustering model and based on the received data, which of the code instances are likely to be associated with each other. Next, each code instance can be grouped into one of a plurality of the groups based on the determination.

In some variations, one group of the plurality of groups is associated with a single user (i.e., the code instances are all determined to be used by a single user, etc. In some cases, the single user can use a single client device (e.g., single mobile phone, tablet, smart watch, etc.). In other cases, the single user can use multiple client devices and the current subject matter is able to associate all these client devices with such user.

In some variations, the groups include code instances that are associated with different users using different client devices.

The IIDs can be based on code embedded in an operating system of each client device.

The IIDs can be based on code embedded in each application that assigns the IIDs to each instance of such application.

The IIDs can be generated by software development kits (SDKs) incorporated into each application.

The received data that characterizes the location of the associated client device can include one or more of (i) a time zone of a clock forming part of an application or an operating system executing on the client device, (ii) a latitude and longitude of the client device, (iii) environmental radio traffic selected from a group consisting of: detected wireless access points, utilized wireless access points, detected beacons, detected cellular base stations, detected radio base stations, detected global navigation system satellites, or detected broadcast television stations, (iv) environmental audio traffic selected from a group consisting of: music detected via a microphone of the client device, voices detected via the microphone of the client device, or noise detected via the microphone of the client device, and/or (v) environmental visual signals selected from a group consisting of: images detected via a camera on the client device, visual patterns detected via a camera on the client device, modulated light detected via a camera or optical sensor on the client device.

The clustering model can be a predictive model. The predictive model can be trained using historical data associated with a plurality of code instances having known devices, users and/or groups of users. The predictive model can include at least one of: a clustering model, a regression model, a neural network, or a support vector machine. The client device can receive data from a server or elsewhere to initiate one or more actions on the client device based on the groups of the code instances.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The subject matter described herein provides many technical advantages. For example, the current subject matter enables clustering of services being executed on client devices belonging to a single user and/or a group of users without such users providing input.

In addition, the current subject matter is advantageous in that it allows for the associating of services or devices a user moves across as belonging to the same user without requiring the user to provide input to indicate this or self-identifying him or herself on each service or device. Such seamless association is advantageous in that it enables auto-synchronization across services without user input (including the ability for a user to pick up on a new service or client device where he or she left off on a different service or client device). Further, the current subject matter obviates the requirement of remembering login/password combinations to merely access a service that does not require security. Alternatively, it enables another factor of authentication when a user begins use of another service or client device, etc. Still further, the current subject matter allows for enhanced and sometimes anonymous profiling of users across services or devices thereby allowing for more effective advertising and marketing tools (as measured by conversion, attribution, segmentation, etc.).

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a system diagram illustrating a plurality of client devices having code instances interacting with a server; and

FIG. 2 is a process flow diagram illustrating grouping of code instances based on location data from a plurality of client devices.

### DETAILED DESCRIPTION

The current subject matter provides systems, apparatus, methods and computer program products for clustering instances of code being executed across multiple services or client devices with, in some cases, a single user, and in other cases, with a group of users without the need for each user to actively provide input (e.g. login/self-identify or otherwise). This clustering information can then be used for various purposes such as providing uniform user experience across services from the same source/company, different instances of a same application, providing similar actions/messaging to groups of users that have been shown to be frequently at a same location as each other, and the like.

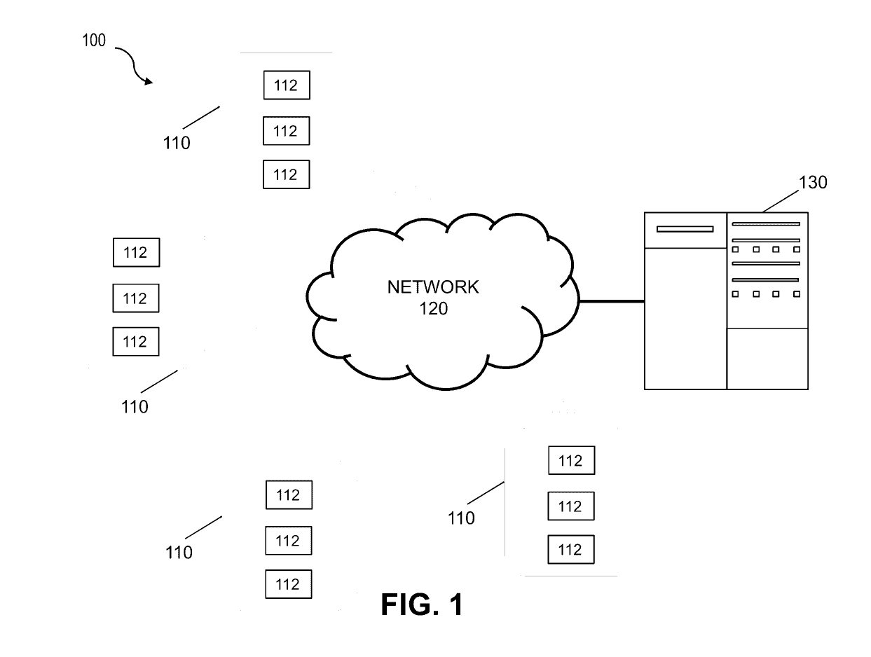

FIG. 1 is a diagram 100 in which there are a plurality of client devices 110 running code 112 that communicate with a remote server 130 via a communications network 120 (which can facilitate wireless communications along at least a portion of the communications network). The above clustering can be implemented by having code 112 embedded into applications and/or operating systems across various types of client devices 110 (e.g., smartphones, tablets, phablets, smart watch, and other portable computing client devices). Such code can comprise routines that collect ambient information (e.g., detected wireless access points, utilized wireless access points, detected beacons, detected cellular base stations, detected radio base stations, detected global navigation system satellites, or detected broadcast television stations, etc.) and send it along with the code instance identifier to the server 130 on a regular basis (or in some variations on demand). The code 112 can, for example, form part of a software development kit (SDK). In some cases, there are multiple code instances 112 sending data to the server 130 over the network 120 at any given time.

The data transmitted by instances of the code 112 on the client devices 110 to the remote server 130 can characterize (i.e., comprise, specify, etc.) a location of the client device 110 at any given time (sometimes referred to herein as location data). In some variations, the code 112 can transmit location data at given intervals or it can transmit such location data upon triggering events. The triggering can include, for example, user interaction with an application, a request from the remote server 130, and other events.

The data transmitted by instances of the code 112 on the client device 110 can also include an instance identifier (IID) that uniquely identifies each instance. The IIDs can be from the operating system and/or assigned by an application in which the code 112 is embedded and/or spontaneously generated by the code instance itself and/or assigned by the server 130 to which the code 112 sends data.

Unless otherwise specified, the location data can be information that either directly identifies the location of the client device or provides other information that can be used to derive either a location of the client device or whether one client device is proximal to another client device. In some cases, the location data comprises timestamps that identify when the particular location information was obtained/captured by the corresponding client device 110.

In some cases, the location data specifies a time zone of the client device 110 (as indicated by an application and/or an operating system of the client device 110). The location data can specify a latitude and/or longitude location of the client device 110 as reported by an application and/or the operating system. Such latitude/longitude information can, for example, be derived from signals such as GPS, Wi-Fi, cellular tower, etc.

The location data can, in some variations, include data characterizing environmental radio traffic as detected by the client device 110. The environmental radio traffic can include, for example, one or more of identifiers of detected WiFi access points (e.g., the user assigned name for the access points and/or the manufacturer assigned router identification, etc.), identifiers of detected wireless beacons (such as those provided by Gimbal, Inc. and/or beacons operating according to the iBeacon protocol promoted by Apple Inc., the Eddystone protocol promoted by Google Inc., etc.), identifiers of detected cell towers, identifiers of detected radio towers, identifiers of detected television towers, and/or the like.

The location data can, in some variations, include environmental audio traffic data that identifies detected music, voices, and/or noise (as detected by the client device 110). The environmental audio traffic data can comprise raw audio files which are then analyzed and/or clustered on the remote server 130. In other cases, the environmental audio traffic data is locally analyzed and the results of the analysis are sent to the remote server for clustering. For example, dB measurements, sound patterns, identified songs, identified sounds, identified voices, and the like.

The location data can, in some variations, include environmental visual signal data that identifies detected images, patterns, and/or modulated light (as detected by the client device 110). The environmental visual signal data can comprise raw image files which are then analyzed and/or clustered on the remote server 130. In other cases, the environmental visual signal data is locally analyzed on the client device 110 and the results of the analysis are sent to the remote serve 130r for clustering. For example, luminosity measurements, identified images, identified patterns, identified faces, identified objects, and the like. The environmental signal data can be detected via a camera or other sensor (e.g., optical sensor, etc.) on the client device 110.

Further, the location information can include data derived from one or more sensors forming part or connected to the client device 110. For example, an air pressure sensor can be used to specify altitude. A thermometer can specify ambient temperature. Physiological sensors can characterize attributes of the user heartrate, and the like. Accelerometers and gyroscopes within the client device 110 can also be used to characterize a relative position and/or movement of the client device 110 including gait of the user, change in direction of the device, etc.

The remote server 130 can compare the data from all the code instances 112 on one or more client devices 110 to find matching patterns and determine that various devices belong to a user (whether or not on a single client device 110 or multiple client devices 110) or group of users. This type of matching can be performed using, for example, one or more clustering models that are used to determine which attributes/variables are likely from the same user or an associated user. In some variations, the clustering models can statistically determine the how similar the location data from a first code instance is to a second code instance in order to induce the two code instances 112 belong to the same device and/or user and/or group of users. It will be appreciated that the foregoing is a simple example in that clusters can be determined among numerous (dozens, hundreds, thousands) code instances to determine a likelihood of whether code instances 112 are likely to be part of a same client device 110 or a group of client devices 110 that are often at a same or proximal location.

A variety of clustering algorithms can be applied to a subset or total of the received data collected by the IIDs. For example: latitude/longitude data can be plotted on a X, Y graph and analyzed by defining a maximum acceptable distance between IID reported latitude/longitude points to be considered part of the same cluster. The maximum acceptable distance can be developed by trying a variety of possible values using known IIDs belonging to one or more known clusters that one wishes to identify and then reviewing whether the results match these known clusters. All IIDs clustered together based on this data can then considered belonging to the same group (a single device, group of devices belonging to the same user or group of devices belonging to the same group of users). Furthermore, the timestamp of the collected latitude/longitude data can be added as an additional variable to this analysis. This allows creating cluster over time whereby an IID may be part of various different clusters during the hours of the day (a family cluster at night, a work cluster on weekdays), during days of the week (a work cluster on weekdays, a golf member cluster on weekends), during months of the year (a tourist cluster during holidays), etc. Similarly, the environmental radio traffic or audio traffic can be substituted for the longitude/latitude data using the assumption that IIDs detecting similar traffic are likely located in a similar latitude/longitude (whether that means a large area like a city or more precise area like a home or display in a retail store).

In some variations, the clustering model can comprise a predictive model that is used to determine whether code instances 112 are likely to be associated to a device and/or user across one or more client devices 110 and/or from a group of related users across different client devices 110. The predictive model can, in some cases, be trained using historical data across a large population of code instances having known devices and/or users and/or having known user groups. For example, location data for code instances that correspond to known applications used by a single user across different types of client device 110 can be accumulated for a large population across multiple days. This accumulated location data with known users can be used to train the predictive model. The predictive model can use a variety of predictive technologies, including, for example, clustering models, regression models, neural networks, support vector machines, and the like in order to make the clustering determination(s).

In some cases, the code 112 on the client devices 110 can receive data from the remote server 130 which can cause the underlying application or operating system to take one or more actions on the corresponding client device 110. For example, this received data can cause an application or the operation system executing on the corresponding client 110 to take an action such as waking up, sending a notification, displaying an advertisement, collecting environmental radio and/or audio traffic to send back and the like.

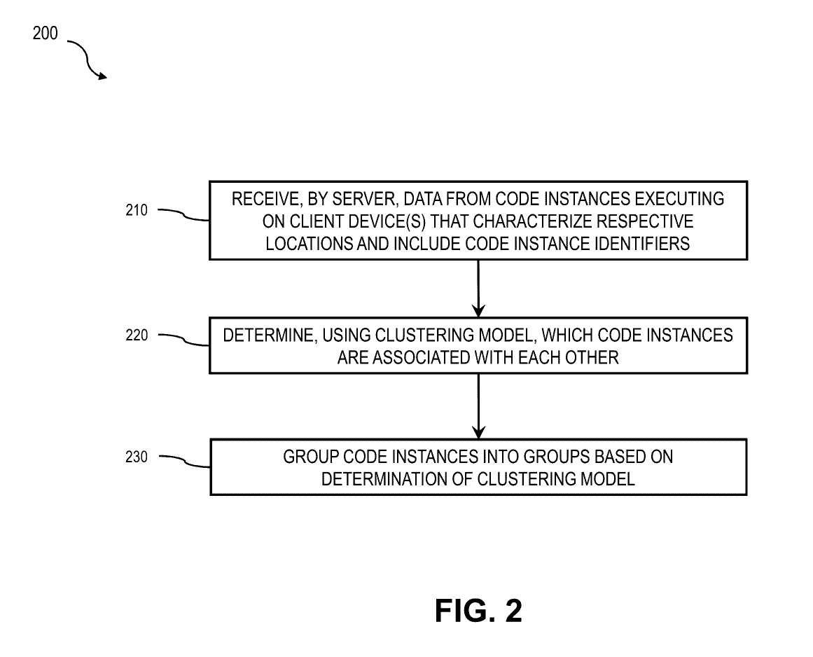

FIG. 2 is a diagram 200 in which, at 210, a server receives data from each of a plurality of code instances which are executing on one or more client devices. This data characterizes a location of the associated client device and comprises a unique instance identification (IID) that identifies that instance of client code executing on the corresponding client device. Subsequently, at 220, it can be determined, using a clustering model and based on the received data, which of the code instances are likely to be associated with each other (e.g. on same device and/or belong to same user and/or belong to users in the same group). Thereafter, at 230, the code instances are grouped into a plurality of groups based on the determination.

The effectiveness of the current subject matter can be increased if an owner of the system broadly distributes environmental markers that create radio traffic, audio traffic, and the like that can be recognized by server as belonging to particular locations or areas. For example, an owner can distribute an array of beacons among an area of interest that can be used to help generate the location data needed by the clustering model to group code instances.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

1. A method comprising:
receiving, by a server from each of a plurality of code instances corresponding to one more software applications, data characterizing a location and associated time for such location of one of a plurality of associated client devices each executing the corresponding code instance and comprising a unique instance identification (IID) that identifies such code instance;
determining, using a clustering model and based on the received data, which of the code instances are likely to be associated with each other based on temporal positions of the code instances in relation to temporal positions of other code instances; and
grouping each code instance into one of a plurality of groups based on the determination;
wherein the IIDs are based on code embedded in each application that assigns the IIDs to each instance of such application.

2. The method of claim 1, wherein one group of the plurality of groups is associated with a single user.

3. The method of claim 2, wherein the at least one group is associated with a single user in which all code instances forming part of the group are executed by a single client device.

4. The method of claim 2, wherein the at least one group is associated with a single user in which code instances forming part of the group are executed across two or more client devices.

5. The method of claim 1, wherein at least one of the groups comprises code instances associated with different users using different client devices.

6. The method of claim 1, wherein the IIDs are based on code embedded in an operating system of each client device.

7. (canceled)

8. The method of claim 1, wherein the IIDs are generated by software development kits (SDKs) incorporated into each application.

9. The method of claim 1, wherein the received data characterizing the location of the associated client device comprises:
a time zone of a clock forming part of an application or an operating system executing on the client device.

10. The method of claim 1, wherein the data characterizing the location of the associated client device comprises:
a latitude and longitude of the client device.

11. The method of claim 1, wherein the data characterizing the location of the associated client device comprises:
environmental radio traffic selected from a group consisting of: detected wireless access points, utilized wireless access points, detected beacons, detected cellular base stations, detected radio base stations, detected global navigation system satellites, or detected broadcast television stations.

12. The method of claim 1, wherein the data characterizing the location of the associated client device comprises:
environmental audio traffic selected from a group consisting of: music detected via a microphone of the client device, voices detected via the microphone of the client device, or noise detected via the microphone of the client device.

13. The method of claim 1, wherein the data characterizing the location of the associated client device comprises:
environmental visual signals selected from a group consisting of: images detected via a camera on the client device, visual patterns detected via a camera on the client device, modulated light detected via a camera or optical sensor on the client device.

14. The method of claim 1, wherein the clustering model comprises a predictive model.

15. The method of claim 14, wherein the predictive model is trained using historical data associated with a plurality of code instances having known devices, users and/or groups of users.

16. The method of claim 14, wherein the predictive model comprises at least one of: a clustering model, a regression model, a neural network, or a support vector machine.

17. The method of claim 1 further comprising:
receiving, by the client device, data to initiate one or more actions on the client device based on the groups of the code instances.

18. A system comprising:
a plurality of client devices each comprising memory and at least one data processor executing at least one code instance corresponding to one or more software applications;
a server comprising memory and at least one data processor;
wherein:
the server receives data from each code instance that characterizes a location and associated time for such location of an associated client device executing the corresponding code instance and comprising a unique instance identification (IID) that identifies such code instance;
it is determined, using a clustering model and based on the received data, which of the code instances are likely to be associated with each other based on temporal positions of the code instances in relation to temporal positions of other code instances; and
each code instance is grouped into one of a plurality of groups based on the determination.

19. The system of claim 17, wherein the received data characterizing the location of the associated client device comprises at least one of:
a time zone of a clock forming part of an application or an operating system executing on the client device;
a latitude and longitude of the client device;
environmental radio traffic selected from a group consisting of: detected wireless access points, utilized wireless access points, detected beacons, detected cellular base stations, detected radio base stations, detected global navigation system satellites, or detected broadcast television stations;
environmental audio traffic selected from a group consisting of: music detected via a microphone of the client device, voices detected via the microphone of the client device, or noise detected via the microphone of the client device; or
environmental visual signals selected from a group consisting of: images detected via a camera on the client device, visual patterns detected via a camera on the client device, modulated light detected via a camera or optical sensor on the client device.

20. A non-transitory computer program product storing instructions which, when executed by at least one data processor forming part of at least one computing device, result in operations comprising:
receiving, by a server from each of a plurality of code instances corresponding to one of a a plurality of applications, data characterizing a location and associated time for such location of one of a plurality of associated client devices each executing the corresponding code instance and comprising a unique instance identification (IID) that identifies such code instance;
determining, using a clustering model and based on the received data, which of the code instances are likely to be associated with each other based on temporal positions of the code instances in relation to temporal positions of other code instances; and
grouping each code instance into one of a plurality of groups based on the determination.

21. The non-transitory computer program product of claim 20, wherein the received data characterizing the location of the associated client device comprises at least one of:
a time zone of a clock forming part of an application or an operating system executing on the client device;
a latitude and longitude of the client device;
environmental radio traffic selected from a group consisting of: detected wireless access points, utilized wireless access points, detected beacons, detected cellular base stations, detected radio base stations, detected global navigation system satellites, or detected broadcast television stations;
environmental audio traffic selected from a group consisting of: music detected via a microphone of the client device, voices detected via the microphone of the client device, or noise detected via the microphone of the client device; or
environmental visual signals selected from a group consisting of: images detected via a camera on the client device, visual patterns detected via a camera on the client device, modulated light detected via a camera or optical sensor on the client device.

22. The method of claim 1, wherein at least one of the client devices executes two more of the code instances on a single client device using different services.

23. The method of claim 1, wherein the determination using the clustering model determines which code instances are associated with a single user across multiple client devices.

24. The method of claim 1, wherein the determination using the clustering model groups code determines code instances that are likely to be part of a same client device or a group of client devices that are often at a same or proximal location so that uniform user experiences can be provided across application instances on a same client device or on a group of client devices.
